(19) United States
(12) Patent Application Publication
(10) Pub. No.: US 2011/0051286 A1
(43) Pub. Date: Mar. 3, 2011

(54) WRITING DATA ON ALTERNATING MAGNETIC AND NONMAGNETIC STRIPES OF A SERVO PATTERN

(75) Inventors: PUSKAL PRASAD POKHAREL, BLOOMINGTON, MN (US); MUSTAFA CAN OZTURK, BLOOMINGTON, MN (US); BARMESHWAR WIKRAMADITYA, EDEN PRAIRIE, MN (US); ALEXEI H. SACKS, EDINA, MN (US); SUNDEEP CHAUHAN, FREMONT, CA (US); DAVID SHIAO-MIN KUO, PALO ALTO, CA (US)

(73) Assignee: SEAGATE TECHNOLOGY LLC, SCOTTS VALLEY, CA (US)

(21) Appl. No.: 12/551,926

(22) Filed: Sep. 1, 2009

(51) Int. Cl. G11B 5/74

(52) U.S. Cl. 360/131; G9B/5.289

(57) ABSTRACT

A recordable magnetic media includes a servo pattern having a plurality of adjacent alternating magnetic and nonmagnetic material stripes. At least some of the magnetic material stripes have magnetic transitions that define encoded data.

### BACKGROUND

The present invention generally relates to data storage media and devices, and more particularly to data storage devices that utilize discrete track media.

As the areal density of magnetic disc drives increases, so does the need for more precise head position control when track following, especially in the presence of vibrations which can cause repeatable and non-repeatable runout error in head positioning and variation in disk speed. Insufficient precision in bead position control can result in unacceptable track misregistration (TMR), which may result in erasure of adjacent tracks during writing and/or unacceptable noise during reading due to sensing of adjacent tracks. In an attempt to improve TMR margin and recording signal to noise ratio (SNR), some magnetic disk media are patterned to form discrete data tracks, referred to as discrete track recording (DTR). DTR disks typically have a series of concentric raised zones (also known as hills, lands, elevations, etc.) for storing data and recessed zones (also known as troughs, valleys, grooves, etc.) that provide inter-track isolation to reduce noise.

### SUMMARY

Servo data can be encoded across a servo pattern that includes a plurality of adjacent alternating magnetic and nonmagnetic material stripes.

In some embodiments, a recordable magnetic media includes a servo pattern having a plurality of adjacent alternating magnetic and nonmagnetic material stripes. At least some of the magnetic material stripes have magnetic transitions that define encoded data.

In some other embodiments, an apparatus includes a recordable magnetic media and a data encoder circuit. The recordable magnetic media has a servo pattern with a plurality of adjacent alternating magnetic and nonmagnetic material stripes, at least some of the magnetic material stripes having magnetic transitions that define encoded data. The data encoder circuit encodes data and writes the encoded data as magnetic transitions in the magnetic material stripes.

In some other embodiments, a recordable magnetic media is provided that includes a servo pattern having a plurality of adjacent alternating magnetic and nonmagnetic material stripes. Decoded data is written through a read/write head onto the alternating magnetic and nonmagnetic material stripes so that magnetic transitions in each data bit occur on the nonmagnetic material stripes.

### DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 illustrates a servo pattern having alternating magnetic and nonmagnetic material stripes in a downtrack direction and which have magnetic transitions that represent synchronously written (relative to the magnetic and nonmagnetic material stripe pattern) encoded data, such as repeatable runout data, in accordance with some embodiments;

FIG. 2 illustrates a block diagram of disk drive electronics that may read and write encoded data to the exemplary servo pattern of FIG. 1 and control head positioning responsive to the servo pattern in accordance with some embodiments;

FIG. 3 illustrates another servo pattern having alternating magnetic and nonmagnetic material stripes in a downtrack direction and which has magnetic transitions that represent asynchronously written encoded data, such as repeatable runout data, in accordance with some embodiments;

FIG. 4 illustrates another servo pattern with alternating magnetic and nonmagnetic material stripes having more narrow downtrack widths and which has magnetic transitions that represent written encoded data, such as repeatable runout data, in accordance with some embodiments;

FIG. 5 illustrates another servo pattern with alternating magnetic and nonmagnetic material stripes in a crosstrack direction and which has magnetic transitions that represent asynchronously written encoded data, such as repeatable runout data, in accordance with some embodiments;

FIG. 6 illustrates another servo pattern with first and second downtrack adjacent radial columns of crosstrack alternating magnetic and nonmagnetic material stripes, where at least some of the magnetic material stripes have magnetic transitions that represent asynchronously written encoded data, such as repeatable runout data, in accordance with some embodiments;

FIG. 7 illustrates another servo pattern with first and second downtrack adjacent radial columns of crosstrack alternating magnetic and nonmagnetic material stripes, where at least some of the magnetic material stripes have increased crosstrack widths relative to the strips of FIG. 8 in accordance with some embodiments; and

FIG. 8 illustrates exemplary fields and information that may be included in a servo pattern in accordance with some embodiments.

### DETAILED DESCRIPTION

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. When an element is referred to as being “connected”, “coupled”, or “adjacent” to another element, it can be directly connected, coupled, or immediately adjacent to the other element or intervening elements may be present therebetween. In contrast, when an element is referred to as being “directly connected”, “directly coupled”, or “immediately adjacent” to another element, there are no intervening elements present therebetween. The term “and/or” and “/” includes any and all combinations of one or more of the associated listed items. In the drawings, the size and relative sizes of regions may be exaggerated for clarity. Like numbers refer to like elements throughout.

It will be understood that, although the terms first, second, etc. may be used herein to describe various elements, these elements should not be limited by these terms. These terms are only used to distinguish one element from another. For example, a first region/element/value could be termed a second region/element/value, and, similarly, a second region/element/value could be termed a first region/element/value without departing from the teachings of the disclosure.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Furthermore, various embodiments may take the form of a computer program product on a computer-usable or computer-readable storage medium having computer-usable or computer-readable program code embodied in the medium that is executable by a processor to perform functionality described herein. Accordingly, as used herein, the terms “circuit” and “module” may take the form of digital circuitry, such as computer-readable program code executed by a processor (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Although various embodiments of the present invention are described in the context of disk drives for purposes of illustration and explanation only, the present invention is not limited thereto. It is to be understood that the present invention can be more broadly used for writing data on recordable magnetic media. Accordingly, although a recordable magnetic media can include a disk of the disk drive, it is not limited thereto and may include tape or other types of media. Moreover, although various embodiments are described in the context of discrete track recording (DTR) disk patterns, the invention is not limited thereto and can be more broadly used for other types of patterned media including, without limitation, bit patterned media (BPM).

DTR techniques for patterning a disk can accurately form a pattern of magnetic and nonmagnetic regions. The nonmagnetic regions may be formed as physical grooves into the media that isolate adjacent lands/plateaus of magnetic regions. As explained above, DTR has been applied to increase isolation between data tracks and has further been used to pattern most of the servo fields in servo sectors, which may be DC-erased to encode the corresponding servo information. However, some servo data, such as repeatable runout (RRO), is not known at the time the disk is manufactured and must, instead, be determined after assembly of a disk stack or assembly of the disk drive. These servo data have heretofore been recorded on continuous magnetic recording areas within the servo sectors.

RRO may be caused by patterning errors or writing errors that result in non-circular tracks (e.g., RRO), spindle runout, disk surface warping due to clamping of the disk on the spindle, etc. After assembly of disks on the disk spindle, the RRO can be measured relative to the angular position of the disks. Data that characterizes the RRO for a particular servo sector and associated data tracks can be written onto an adjacent continuous magnetic recording area within the servo sector.

Some embodiments of the present invention, may arise from the present realization that continuous magnetic recording areas can deleteriously affect the head fly height by, for example, causing a large disturbance force on the head as the head air bearing changes from what is created by the pattern of alternating lands and grooves to what is created by the continuous magnetic recording area. Additionally, forming continuous magnetic recording areas within servo sectors may complicate the manufacture process by, for example, making it more difficult to planarize the raised and recessed DTR areas which are adjacent to the continuous magnetic recording areas. Various embodiments of the present invention may improve topographic and non-topographic aspects of patterned media.

In accordance with various embodiments, such continuous magnetic recording areas are broken-up into radial and/or circumferential stripes, and data are coded and written thereon in a manner that allows recovery of the data despite this change. In some embodiments, a servo pattern includes a plurality of adjacent alternating magnetic and nonmagnetic material stripes, and servo data are stored as magnetic transitions on the magnetic stripes. The magnetic material stripes may be formed from a magnetic metal alloy, a metal oxide, and/or a nonmagnetic material that contains magnetic particles that are configured to be selectively magnetized to store data bits. The nonmagnetic stripes may be formed as grooves that separate and isolate the adjacent lands (plateaus) of magnetic material stripes. Alternatively or additionally, the nonmagnetic material stripes may contain a dielectric material that is planar with, or recessed below (e.g., grooves), an upper surface of the magnetic material stripes.

In some further embodiments, each bit of the recorded data is encoded across at least an adjacent pair of the magnetic stripes with one of the nonmagnetic stripes therebetween. The magnetic transitions in each data bit may be encoded to occur during the nonmagnetic stripes, although such alignment is not required. In this manner, the data bits may be wide bi-phase encoded, or encoded with another encoding technique, to generate a readback signal, when read, that is similar to what would be generated if the servo data were instead recorded on a continuous recording area. Consequently, the servo data may be read from the alternating magnetic and nonmagnetic stripes and processed by a read channel circuit that is configured to receive conventional servo data from a continuous recording area.

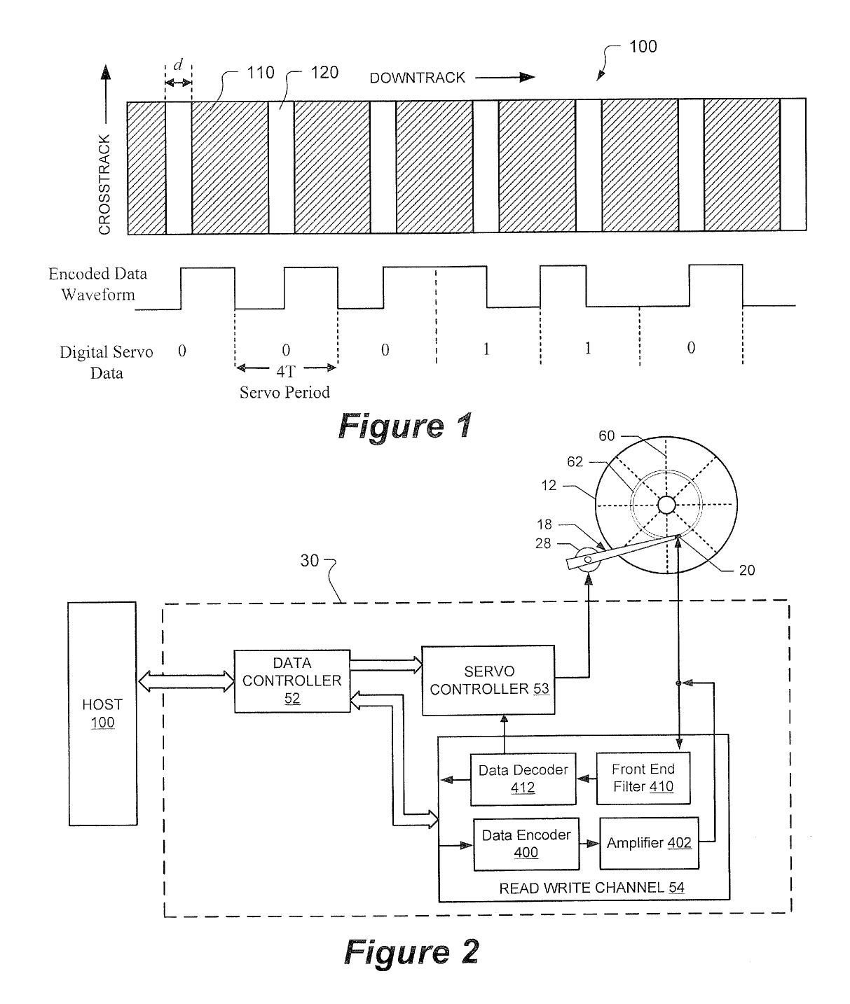

These and various other embodiments are described below with regard to FIGS. 1-8. In a first group of embodiments, the servo data are encoded across a plurality of magnetic and nonmagnetic stripes that alternate in a downtrack direction. In a second group of embodiments, the servo data are encoded along a plurality of magnetic stripes that alternate with nonmagnetic stripes in a crosstrack direction.

FIG. 1 illustrates a portion of a servo pattern 100 that has magnetic stripes 110 (crosshatched stripes) and nonmagnetic stripes 120 (non-crosshatched stripes) that extend in a crosstrack direction (e.g. radially across a disk/tape) relative to adjacent circumferentially extending data tracks, and that alternate in a downtrack direction. The servo pattern 100 may be repeated in each radially extending servo sector around a disk. FIG. 1 further illustrates digital servo data and the corresponding waveform after the data are encoded for writing in a downtrack direction on the servo pattern 100. The digital servo data may characterize RRO that can be used by a servo controller to position a head so as to compensate for the RRO while the head operates to read/write data on a data track.

FIG. 8 illustrates an embodiment of at least a portion of servo information that may be recorded on the servo pattern 100 of FIG. 1 and/or on other embodiments of servo patterns disclosed herein. The servo information can include preamble bursts, servo address Mark (SAM) data, gray code (GC) data, position bursts (e.g., A, B, C, D position bursts), and RRO data that characterize RRO for an adjacent data track. The SAM data, GC data, and/or RRO data may be wide bi-phase encoded, or encoded using another encoding technique, when written onto the servo pattern 100.

As explained above, after assembly of a disk on a disk spindle, RRO of the servo pattern can be measured and the RRO data for a particular servo sector and associated data tracks can be written onto the servo pattern 100. Although other servo information, such as the SAM data and GC data, can be known before manufacture of the disk and may, therefore, be patterned onto the disk during its manufacture, these or other types of servo information may alternatively be written on the servo pattern 100 after manufacture of the disk and assembly onto a rotational spindle. Accordingly, the RRO data, the SAM data, the GC data, and/or other servo data may be written through a head onto the servo pattern 100.

In the exemplary embodiment of FIG. 1, the digital servo data include a “000110” bit pattern. A data encoder circuit in the disk drive encodes the bit pattern to generate the illustrated encoded data waveform which is written onto the servo pattern 100. In accordance with some embodiments, each data bit is encoded and written at four times the servo clock period (4T) so that each encoded data bit is written with a majority of the high or low levels of the waveform (thus the corresponding magnetic polarizations) recorded on the magnetic stripes 110. Thus, the each data bit may extend across at least an adjacent pair of magnetic stripes 110 with one of the nonmagnetic stripes 120 therebetween. Although each data bit is shown in FIG. 1 as being encoded across two adjacent magnetic stripes 110, it is to be understood that each data bit may be written across any plural number of the magnetic stripes 110.

The encoded data waveform may be written in a synchronous manner relative to the servo pattern 100. The encoded transitions in each data bit may be timed to occur during the nonmagnetic stripes 120 and, may preferably, be timed to occur at a center of the nonmagnetic stripes 120. However, the transitions may occur over the magnetic stripes 110. For example, referring to FIG. 1, the transitions from low to high levels in the data waveform for each of the four servo data bits “0” occur during four of the nonmagnetic stripes 120. Similarly, the transitions from high to low levels in the data waveform for each of the two servo data bits “1” occur during two of the nonmagnetic stripes 120. Because the rapid transitions from low to high levels and from high to low levels in the data waveform occurs over the nonmagnetic stripes 120, the readback signal that is generated as a head reads the servo pattern 100 is not subjected to noise from the transitions.

The downtrack width “d” of the nonmagnetic stripes 120 should be minimized to increase data storage density on the disk. The selection of a downtrack width “d” of the nonmagnetic stripes 120 may include a compromise between various constraints, such as avoiding creating head fly height disturbances between data track and servo track zones, facilitating planarization of the patterns during disk manufacture, providing sufficient write synchronization, and/or providing sufficient readback signal integrity.

For example, for the exemplary embodiment of FIG. 1 the downtrack width “d” of the nonmagnetic stripes 120 may be less than or equal to one quarter of the downtrack width of each encoded data bit. As the downtrack width “d” of the nonmagnetic stripes 120 approaches zero, the servo pattern 100 approaches a continuous magnetic recording area. In contrast, when the downtrack width “d” of the nonmagnetic stripes 120 is twice the servo clock rate (2T), the magnetic stripes 110 and the nonmagnetic stripes 120 can have the same downtrack width.

FIG. 2 is a block diagram of disk drive electronic circuits 30 which include a data controller 52, a servo controller 53, and a read/write channel 54. Although two separate controllers 52 and 53 and a read/write channel 54 have been shown for purposes of illustration and discussion, it is to be understood that their functionality described herein may be integrated within a common integrated circuit package or distributed among more than one integrated circuit package. A head disk assembly can include a plurality of data storage disks 12, an actuator arm 18 with a plurality of read/write heads 20 (or other sensors) which are moved radially across different data storage surfaces of the disk(s) 12 by an actuator motor (e.g., voice coil motor) 28, and a spindle motor which rotates the disk(s) 12.

The read/write channel 54 can convert data between the digital signals processed by the data controller 52 and the analog signals conducted through the heads 20. The read/write channel 54 provides servo data that is read from servo sectors 60 on the disk 12 to the servo controller 53. The servo sectors 60 may include the servo data shown in FIG. 8 and may include the servo pattern 100 of FIG. 1 and/or other servo patterns disclosed herein. The read/write channel 54 can include a data encoder 400, an amplifier 402, an AFE filter 410, and a data decoder 412. The data encoder 400 may be configured to encode servo data to generate an encoded data waveform that is amplified by the amplifier 402 and written onto the magnetic stripes of the servo pattern (e.g. servo pattern 100). As explained above, the data encoder 400 may be synchronized to the servo pattern 100 (e.g. via synchronization performed using the preamble field of FIG. 8 in the servo sectors 60) so that the level transitions in the encoded data waveform for each bit occur over the nonmagnetic stripes 120 (e.g., over centers of the nonmagnetic stripes 120).

The readback signal from the servo pattern is filtered by an AFE filter 410 that filters “double peaking” or other distortions caused by the servo data bits being recorded across the nonmagnetic stripes 120. “Double peaking” refers to distortions in the readback signal that may appear as ripples due to the presence of the nonmagnetic stripes. In particular, if a nonmagnetic stripe is around the middle of the negative or positive half cycle of the readback signal, the distortion may appear as two small peaks in that half cycle. The AFE filter 410 may be configured to have a cutoff frequency that removes non-fundamental (e.g., second, third and higher) harmonic content of the readback signal. The data decoder 412 decodes the encoded data from the servo pattern. After filtering by the AFE filter 410, the data decoder 412 may operate in a conventional manner to decode the servo data bits.

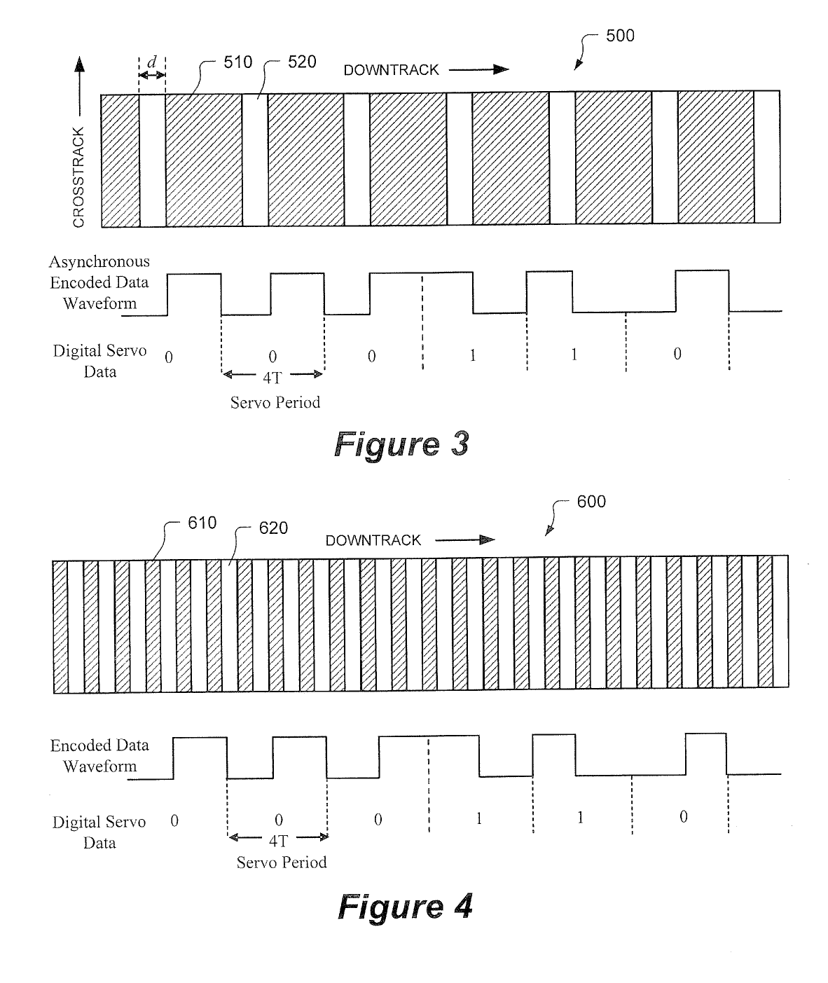

FIG. 3 illustrates a portion of another servo pattern 500 that has magnetic material stripes 510 (crosshatched stripes) and nonmagnetic material stripes 520 (non-crosshatched stripes) that extend in a crosstrack direction (e.g. radially across a disk/tape) and that alternate in a downtrack direction. The servo pattern 500 may be repeated in each radially extending servo sector 60 around the disk 12. FIG. 3 further illustrates digital servo data and the corresponding waveform after the data are encoded for writing in a downtrack direction on the servo pattern 500. The digital servo data may characterize RRO and be used by a servo controller 53 to position the head 20 so as to compensate for RRO while the head 20 operates to read/write data on a data track 62. One difference between FIGS. 1 and 3 is that the encoded data waveform is written asynchronously to the data pattern 500. The level transitions in each servo data bit do not necessarily occur near a center of a nonmagnetic material stripe 520, and the nonmagnetic material stripes 520 (e.g., groove) may occur anywhere in the recorded data bit. The maximum allowed downtrack width “d” of the nonmagnetic stripes 520 may be smaller than that for synchronous writing because known parts of the servo bits will not be written due to the existence of the nonmagnetic stripes 120. However, allowing asynchronous writing of servo data on the servo pattern 500 relaxes requirements on the read/write channel 54 because synchronization to the servo pattern 500 is not required.

The readback signal from reading the servo pattern 500 of FIG. 3 may have various distortions such as uneven duty cycle and double peaking that is dependent upon the phase differences. These distortions may reduce the energy of the first harmonic (servo frequency) of the signal and introduce higher harmonics into the readback signal. The AFE filter can reduce these distortions since the cut-off frequency is set close to the servo frequency.

When the downtrack width is 0, the readback signal will have a waveform that corresponds to that from a continuous magnetic recording area. In contrast, when the downtrack widths are 0.5T or 1T, for example, the readback signal can have double peaking distortion due to the presence of the nonmagnetic stripes occurring in each servo data bit. As the downtrack width “d” increases, the severity of the distortion increases.

An Analog Front End (AFE) filter can be used to filter the analog readback signal. The AFE filter should be configured to substantially remove the distortions due to the grooves (nonmagnetic stripes) between the lands (magnetic stripes) by having a cutoff frequency that removes the higher order harmonic content of the readback signals. Accordingly, with a downtrack width “d” as great as 0.5T for the nonmagnetic stripes, it is believed that the associated readback signal may be properly filtered and processed by a read/write channel of the disk drive to enable proper detection and decoding of the servo data bits recorded therein.

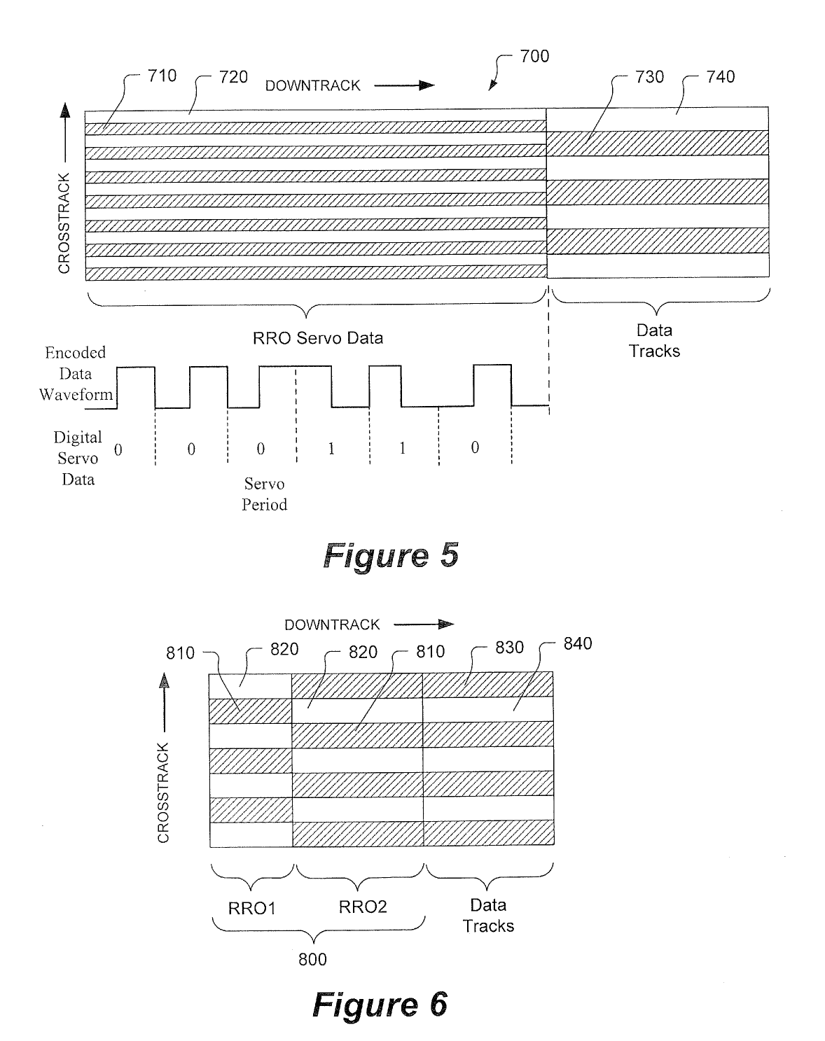

FIG. 4 illustrates another servo pattern 600 with alternating magnetic material stripes 610 and nonmagnetic material stripes 620 that have more narrow downtrack widths than the servo pattern 100 of FIG. 1 and the servo pattern 500 of FIG. 3. Referring to FIG. 4, the combined downtrack width of an adjacent pair of magnetic and nonmagnetic stripes 610 and 620 is less than the period of the encoded data waveform (servo bit length). Accordingly, each encoded servo data bit is written over at least two pairs of magnetic and nonmagnetic stripes 610 and 620 (e.g., a sequence of magnetic, nonmagnetic, magnetic, and nonmagnetic material stripes). The quality of the readback signal may improve as the downtrack widths of the nonmagnetic stripes 620 decreases and the associated servo pattern frequency increases relative to the servo bit frequency. For example, the ripple frequency in the readback signal due to the nonmagnetic stripes 620 will increase and may therefore be more easily removed by the AFE filter 410. As the downtrack widths of the magnetic and nonmagnetic stripes 610 and 620 are varied relative to the servo T, the cutoff frequency of the AFE filter 410 can be tuned to remove the ripples (which may have more ripples than just the double peaks of the patterns of FIGS. 1 and 5) in the readback signal caused by the nonmagnetic stripes 620. The write waveform is not required to be synchronous to the pattern 500. After filtering by the AFE filter 410, the data decoder 412 may operate in a conventional manner to decode the servo data bits.

Although the servo pattern 600 has been illustrated in FIG. 4 with the downtrack widths of the magnetic stripes 610 and the nonmagnetic material stripes 620 being equal, their widths may instead be unequal. The encoded data waveform may be written synchronously or asynchronously to the servo pattern 600.

FIG. 5 illustrates another servo pattern 700 with alternating magnetic material stripes 710 (crosshatched stripes) and nonmagnetic material stripes 720 (non-crosshatched stripes) that extend in a downtrack direction and alternate in a crosstrack direction. The magnetic stripes 710 have magnetic transitions that are recorded therein that represent asynchronously written encoded data, such as RRO data, in accordance with some embodiments.

Referring to FIG. 5, the RRO data of the servo pattern 700 are followed by magnetic material recordable data tracks 730 and nonmagnetic material nonrecordable tracks 740 that alternate in the crosstrack direction and extend in the downtrack direction. The nonrecordable tracks 740 provide isolation between the data tracks 730. The encoded servo data waveform is written onto the magnetic stripes 710. The servo data may be RRO data that characterize repeatable runout of the downtrack adjacent data tracks 730. Different RRO data may be recorded on different magnetic stripes 710 to provide different RRO values for different data tracks 730. The RRO data would typically be written onto the magnetic stripes 710 after assembly of the manufactured disks onto a spindle, such as after assembly of the disk drive.

As shown in the exemplary embodiment of FIG. 5, the crosstrack width of an adjacent pair of the magnetic and nonmagnetic stripes 710 and 720 may be equal to or less than a width of one of the data tracks 730. The data tracks 730 may have the same crosstrack width as the nonrecordable tracks 740, although their widths are not limited thereto. The crosstrack width of the nonmagnetic stripes 740 may be reduced down to a size that, for example, still permits an acceptable isolation between the data tracks 730 and provides sufficient magnetic land for data writing and recovery. In contrast to the servo patterns 100, 500, and 600, continuous magnetic recording areas are provided by the elongated magnetic stripes 710 in the servo pattern 700 for recording the encoded servo data waveform.

As explained above, RRO data that are recorded in servo wedges can be used to control head positioning so as to compensate for the determined RRO while reading and writing data thereto. RRO data that are used to compensate for RRO while reading data may be written aligned with the centerline of the data track. In contrast, the RRO data that are used to compensate for RRO while writing data may be written with varying offset distances from a centerline of the data track accounting for the radial offset between the read and write elements of the head 20 as it moves between inner and outer diameters locations on the disk 12. In accordance with some embodiments, a servo pattern includes radial columns of RRO data followed by the associated data tracks.

FIG. 6 illustrates a servo pattern 800 with first and second downtrack adjacent columns RRO1 and RRO2 of crosstrack alternating magnetic material stripes 810 and nonmagnetic material stripes 820 that store servo data. The alternating magnetic stripes 810 and nonmagnetic stripes 820 in the columns RRO1 and RRO2 are offset in the crosstrack direction. The columns RRO1 and RRO2 of servo data are followed by magnetic material recordable data tracks 830 and nonmagnetic material nonrecordable tracks 840 that alternate in the crosstrack direction and extend in the downtrack direction.

In some embodiments, the first column RRO1 may be used to store Write RRO for specific head (MR) jog offsets, such as, without limitation, a MR jog offset of least 0.25 to no more than 0.75 times the track width. The second column RRO2 may be used to store Read RRO for all other MR jog offsets, and may also be used to store Write RRO as well. Additional error recovery of the Write RRO data may be obtained by writing the Write RRO data to the magnetic stripes 810 in both of the first and second columns RRO1 and RRO2. This redundancy may be particularly beneficial when one of the fields is written with the higher curvature field from the writer element.

In some other embodiments, the same RRO data are written to some of the magnetic stripes 810 in the columns RRO1 and RRO2. For example, a write element of the head 20 may have about the same crosstrack width as one of the recordable data tracks 830 so that when servo data are written onto the servo pattern 800, the head 20 will properly write the servo data onto one magnetic stripe 810 in column RRO1 or in the column RRO2. For example, when the write element of the head 20 is aligned with a data track 830, which in the illustrated configuration of FIG. 6 is aligned with the magnetic stripes 810 of the column RRO2, the servo data are written onto a magnetic material stripe 810 of the column RRO2 but are not written onto the uptrack adjacent nonmagnetic material stripe 820 of the column RRO1. Alternatively, when the head 20 is aligned with a nonmagnetic track 840 between the magnetic track 830, the servo data are written onto a magnetic material stripe 810 of the column RRO1 but are not written onto the downtrack adjacent nonmagnetic material stripe 820 of the column RRO2.

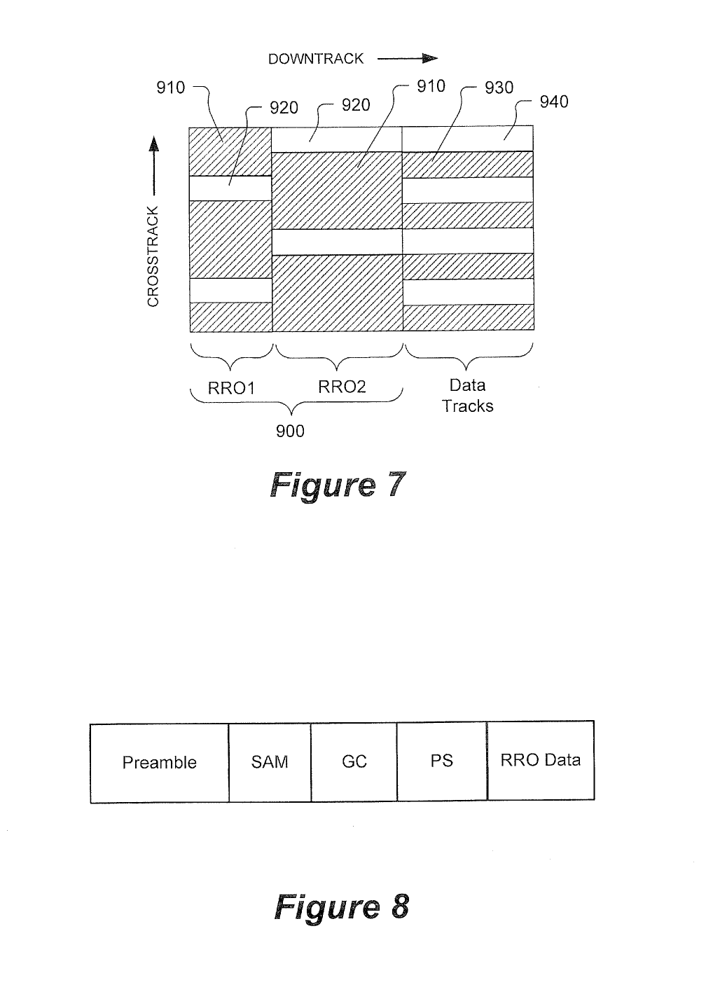

Although the magnetic stripes 810 and nonmagnetic stripes 820 are shown in FIG. 6 as having the same crosstrack width, which may be the same as the data tracks 830, their width is not limited thereto and may be different relative to one another, but should have some radial overlap, such as shown in FIG. 7.

FIG. 7 illustrates another servo pattern 900 with first and second downtrack adjacent columns RRO1 and RRO2 of crosstrack alternating magnetic material stripes 910 (crosshatched areas) and nonmagnetic material stripes 920 (non-crosshatched areas). The magnetic stripes 910 have increased crosstrack widths relative to the magnetic stripes 810 of FIG. 6. In the non-limiting exemplary configuration of the servo pattern 900 shown in FIG. 7, the magnetic stripes 910 have a crosstrack width that is about equal to a combined crosstrack width of an adjacent pair of recordable magnetic data tracks 930 with a nonrecordable nonmagnetic track 940 therebetween, although the relative widths of the stripes 910, 920, 930, and 940 may be greater than or less than that shown in the exemplary embodiment of FIG. 7.

The same or different servo track data may be written to the magnetic stripes 910 in the first and second columns RRO1 and RRO2. In one embodiment, it may be known that at specific fractional MR offsets the data can be more reliably stored in the first column RRO1 or in the second column RRO2 because that particular column will have more surface area of a corresponding one of the magnetic stripes 910 under the write element of the head. Accordingly, at a particular radial location on the disk the disk drive can be configured to write and read data in a predetermined one of the RRO1 and RRO2 columns.

In another embodiment, although it is known that because of fractional MR offsets the data can be more reliably stored in the first or second column, the disk drive does not attempt to determine which of the two columns would provide more accurate storage. Instead, the disk drive attempts to write the data across both of the RRO1 and RRO2 columns and, because of the radial offset and overlap between the magnetic stripes 910 in the respective columns, the data will be written successfully onto the magnetic stripe 910 of at least one of the RRO1 and RRO2 columns. During data readback, the servo firmware can attempt to read the data from the magnetic stripes 910 of at least one of the RRO1 and RRO2 columns and make both readback data sets available to the servo controller which can pick one or the other or a combination thereof after error correction and recovery. Although such redundancy can result in a loss of storage capacity corresponding, the first or second field may also be used to store other information, such as fly-height detection related information, etc.

In yet another embodiment, the Write RRO data may be stored in the magnetic stripes 910 in the first column RRO1, and both Write RRO data and Read RRO data may be stored in the magnetic stripes 910 in the second column RRO2. The downtrack width of the first column RRO1 may be more narrow than the downtrack width of the second column RRO2, such as when the RRO1 is configured to store only Write RRO data and RRO2 is configured to stored both Write RRO data and Read RRO data. The relative geometries of the fields in the first and second columns may be defined as a function of the writer width and the data storage land (magnetic stripes 910) widths.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A recordable magnetic media comprising:
a servo pattern having a plurality of adjacent alternating magnetic and nonmagnetic material stripes, at least some of the magnetic material stripes having magnetic transitions that define encoded data.

2. The recordable magnetic media of claim 1, wherein the magnetic transitions of the magnetic material stripes define encoded data that characterize repeatable runout (RRO) for at least one adjacent data track.

3. The recordable magnetic media of claim 1, further comprising a plurality of data tracks each extending in a downtrack direction and arranged adjacent to each other in a crosstrack direction, wherein the magnetic and nonmagnetic material stripes alternate in the downtrack direction.

4. The recordable magnetic media of claim 1, wherein:
a plurality of data bits are encoded in the magnetic transitions of the magnetic material stripes; and
each data bit is encoded across at least an adjacent pair of the magnetic material stripes with one of the nonmagnetic material stripes therebetween.

5. The recordable magnetic media of claim 4, wherein for the data bits encoded on the magnetic material stripes, magnetic transitions in each data bit are encoded to occur during the nonmagnetic material stripes.

6. The recordable magnetic media of claim 4, wherein a downtrack width of each encoded data bit is greater than a downtrack width of one of the magnetic material stripes.

7. The recordable magnetic media of claim 4, wherein the nonmagnetic material stripes each have a downtrack width that is not greater than one quarter of a downtrack width of each encoded data bit.

8. The recordable magnetic media of claim 1, further comprising a plurality of magnetic material data tracks each extending in a downtrack direction and arranged adjacent to each other in a crosstrack direction, wherein the magnetic and nonmagnetic material stripes extend in the downtrack direction and alternate in the crosstrack direction, and at least some of the magnetic material stripes having magnetic transitions that define the encoded data.

9. The recordable magnetic media of claim 8, wherein a crosstrack width of an adjacent pair of the magnetic and nonmagnetic material stripes is not greater than a width of one of the magnetic material data tracks.

10. The recordable magnetic media of claim 1, further comprising a plurality of magnetic material data tracks each extending in a downtrack direction and arranged adjacent to each other in a crosstrack direction with a nonmagnetic material track between each adjacent pair of the magnetic material data tracks, wherein a first radial column of the magnetic and nonmagnetic material stripes extends in the downtrack direction and alternates in the crosstrack direction, a second radial column of the magnetic and nonmagnetic material stripes extends between the first radial column and the data tracks and alternates in the crosstrack direction, the magnetic material stripes in the first and second radial columns are offset relative to each other in the cross track direction, and at least some of the magnetic material stripes of the first and second radial columns have magnetic transitions that define the encoded data.

11. The recordable magnetic media of claim 10, wherein:
the magnetic material stripes in the first and second columns are offset relative to each other in the crosstrack direction a distance that is at least equal to a width of one of the magnetic material data tracks.

12. The recordable magnetic media of claim 10, wherein:
a crosstrack width of the magnetic material stripes in the first and second columns is at least as great as twice a crosstrack width of an adjacent pair of the magnetic material data tracks.

13. An apparatus comprising:
a recordable magnetic media having a servo pattern with a plurality of adjacent alternating magnetic and nonmagnetic material stripes, at least some of the magnetic material stripes having magnetic transitions that define encoded data; and
a data encoder circuit that encodes data and writes the encoded data as magnetic transitions in the magnetic material stripes.

14. The apparatus of claim 13, wherein:
the magnetic and nonmagnetic material stripes of the servo pattern alternate in a downtrack direction, and the data encoder circuit writes each of the encoded data bits across at least an adjacent pair of the magnetic material stripes with one of the nonmagnetic material stripes therebetween on the servo pattern.

15. The apparatus of claim 14, wherein:
the data encoder circuit encodes writes the encoded data bits so that magnetic transitions in each data bit occur over the nonmagnetic material stripes.

16. The apparatus of claim 13, wherein:
the data encoder circuit writes the encoded data bits so that a downtrack width of each encoded data bit is no less than a combined downtrack width of an adjacent pair of magnetic and nonmagnetic material stripes.

17. The apparatus of claim 13, wherein:
the data encoder circuit writes the encoded data bits as magnetic transitions on one of a plurality of magnetic material strips in either a first column or a second column, the first column comprising magnetic and nonmagnetic material stripes extending in a downtrack direction and alternating in a crosstrack direction, the second column comprising magnetic and nonmagnetic material stripes extending between the first column and data tracks and alternating in the crosstrack direction, the magnetic material stripes in the first and second columns being offset relative to each other in the cross track direction.

18. A method comprising:
providing a recordable magnetic media including a servo pattern having a plurality of adjacent alternating magnetic and nonmagnetic material stripes; and
writing encoded data through a read/write head onto the alternating magnetic and nonmagnetic material stripes so that magnetic transitions in each data bit occur on the nonmagnetic material stripes.

19. The method of claim 18, further comprising:
writing each encoded data bit across at least a portion of both of two adjacent magnetic material stripes with a nonmagnetic material stripe therebetween.

20. The method of claim 18, wherein the encoded data written onto the magnetic material stripes characterize repeatable runout (RRO) for at least one adjacent data track.
